(19) United States
(12) Patent Application Publication
(10) Pub. No.: US 2025/0224964 A1
(43) Pub. Date: Jul. 10, 2025

(54) Logically concatenating a thin-provisioned block storage volume with a standard boot volume

(71) Applicant: Datafy Ltd., Tel Aviv (IL)

(72) Inventors: Yoav Ilovich, Tel-Aviv (IL); Dan Cohen, Raanana (IL); Jacob Hanna, Rameh (IL)

(21) Appl. No.: 19/000,780

(22) Filed: Dec. 24, 2024

Related U.S. Application Data
(60) Provisional application No. 63/619,333, filed on Jan. 10, 2024.

(51) Int. Cl. G06F 9/4401; G06F 16/11

(52) U.S. Cl. CPC G06F 9/4403; G06F 16/122

(57) ABSTRACT

A method for use with a boot volume, which is not thin-provisioned, on at least one remote device includes, using a processor of a local device, allocating, for storage of data, a thin-provisioned block storage volume on the at least one remote device, and using the processor, logically concatenating the thin-provisioned block storage volume with the boot volume with respect to read and write operations by a file system running on the local device, by mapping any logical address provided by the file system and less than a size of the boot volume to an equivalent physical address in the boot volume, and mapping other logical addresses provided by the file system to provisioned physical addresses in the thin-provisioned block storage volume. Other embodiments are also described.

### CROSS-REFERENCE TO RELATED APPLICATIONS

The present application claims the benefit of U.S. Provisional Application 63/619,333, entitled “Thin provisioning an existing boot volume without modifying the bootloader,” filed Jan. 10, 2024, whose disclosure is incorporated herein by reference.

### FIELD OF EMBODIMENTS OF THE INVENTION

Embodiments of the present invention relate generally to computer storage systems, and specifically to the allocation and usage of remote block storage volumes.

### BACKGROUND

Block storage volumes are a fundamental component of modern computer storage systems, providing a method for storing data in fixed-size blocks. Each block is identified by a unique address, allowing for efficient and direct access to data. Block storage is commonly used in various types of storage devices, including hard drives, solid-state drives, and storage area networks. This type of storage is highly versatile and can be used for a wide range of applications, from simple file storage to complex database management.

However, managing block storage volumes can be challenging, especially when it comes to optimizing storage utilization and ensuring efficient allocation of resources. Thin provisioning addresses this challenge, by dynamically allocating storage capacity as needed, rather than pre-allocating the entire storage space upfront. Thin provisioning allows for more efficient use of storage resources, reducing the need for over-provisioning and minimizing wasted space.

### SUMMARY

There is provided, in accordance with some embodiments of the present invention, a system for use with a boot volume, which is not thin-provisioned, on at least one remote device. The system includes a memory, configured to load program instructions, and a processor. The processor is configured to run a file system, and by executing the program instructions, to allocate, for storage of data, a thin-provisioned block storage volume on the at least one remote device, and to logically concatenate the thin-provisioned block storage volume with the boot volume with respect to read and write operations by the file system, by mapping any logical address provided by the file system and less than a size of the boot volume to an equivalent physical address in the boot volume, and mapping other logical addresses provided by the file system to provisioned physical addresses in the thin-provisioned block storage volume.

There is further provided, in accordance with some embodiments of the present invention, a method for use with a boot volume, which is not thin-provisioned, on at least one remote device. The method includes, using a processor of a local device, allocating, for storage of data, a thin-provisioned block storage volume on the at least one remote device. The method further includes, using the processor, logically concatenating the thin-provisioned block storage volume with the boot volume with respect to read and write operations by a file system running on the local device, by mapping any logical address provided by the file system and less than a size of the boot volume to an equivalent physical address in the boot volume, and mapping other logical addresses provided by the file system to provisioned physical addresses in the thin-provisioned block storage volume.

There is further provided, in accordance with some embodiments of the present invention, a computer software product for use with a boot volume, which is not thin-provisioned, on at least one remote device. The computer software product includes a tangible non-transitory computer-readable medium in which program instructions are stored. The instructions, when read by a processor of a local device on which a file system runs, cause the processor to allocate, for storage of data, a thin-provisioned block storage volume on the at least one remote device. The instructions further cause the processor to logically concatenate the thin-provisioned block storage volume with the boot volume with respect to read and write operations by the file system, by mapping any logical address provided by the file system and less than a size of the boot volume to an equivalent physical address in the boot volume, and mapping other logical addresses provided by the file system to provisioned physical addresses in the thin-provisioned block storage volume.

In some embodiments, the remote device belongs to a cloud-computing platform.

In some embodiments, the instructions cause the processor to allocate the thin-provisioned block storage volume, and to logically concatenate the thin-provisioned block storage volume with the boot volume, without modifying a bootloader of the remote device.

In some embodiments, the program instructions include a driver.

In some embodiments, a boot sequence defined in the boot volume includes a command to load the program instructions.

In some embodiments, the instructions cause the processor to logically concatenate the thin-provisioned block storage volume with the boot volume while interposing between a block device application program interface of the local device and a block device driver of the remote device.

In some embodiments, the instructions cause the processor, in allocating the thin-provisioned block storage volume, to set a physical size of the thin-provisioned block storage volume based on a configuration input from a user of the local device indicating a desired logical size of the thin-provisioned block storage volume.

In some embodiments,
the local device initially uses, for the storage of the data, another block storage volume that is not thin-provisioned,
the instructions further cause the processor to compute a size of the data stored in the block storage volume, and
the instructions cause the processor, in allocating the thin-provisioned block storage volume, to set a physical size of the thin-provisioned block storage volume based on the size of the data.

In some embodiments, the instructions further cause the processor to output an alert in response to the thin-provisioned block storage volume being almost full.

In some embodiments, the instructions further cause the processor to expand the thin-provisioned block storage volume in response to the thin-provisioned block storage volume being almost full.

The present invention will be more fully understood from the following detailed description of embodiments thereof, taken together with the drawings, in which:

### BRIEF DESCRIPTION OF THE DRAWINGS

FIG. 1 is a schematic illustration of a system for efficient remote block storage, in accordance with some embodiments of the present invention;

FIG. 2 is a flow diagram for the execution of a driver, in accordance with some embodiments of the present invention; and

FIG. 3 is a schematic illustration of a mapping between a logical address space and a storage volume, in accordance with some embodiments of the present invention.

### DETAILED DESCRIPTION

### Overview

Users of block storage volumes on remote servers face a challenge when trying to use thin provisioning. In particular, the boot volumes on these servers are typically generated from pre-existing templates, which are typically supplied by an operating-system vendor or cloud vendor. These templates do not provide thin provisioning as an option, as to do so would require modification of the bootloader to support thin provisioning, which is complicated and is not supported by any known distribution.

One way to address this challenge is to split the boot volume from the data volume that is to be used for data storage, and to enable thin provisioning only for the data volume. However, splitting the storage in this way adds an extra layer of complication. In practice, for simplicity, users tend to subscribe to a single block volume-in particular, a large boot volume-for both the booting sequence and data storage, and thus do not benefit from thin provisioning.

Hence, embodiments of the present invention provide an alternate solution. A driver, or any other suitable piece of software code configured to perform the functionality of the driver as described herein, is installed on the user's local device. The driver is configured to allocate a remote thin-provisioned data volume and to logically concatenate this volume with a remote boot volume, which is not thin-provisioned, such that the file system on the local device sees a single, concatenated block storage volume. In particular, the driver translates logical addresses specified by the file system to physical addresses on the concatenated volume, whereby the translation includes a logical-to-physical indirection layer for logical addresses belonging to the data volume.

For example, it will be supposed that the user requires 10 GB for a boot volume and 90 GB for data storage. Without embodiments of the present invention, the user would most likely allocate a non-thin-provisioned boot volume of 100 GB, leading to overpayment and inefficient use of resources. On the other hand, with embodiments of the present invention, 10 GB could be allocated for the boot volume, and an amount of space smaller than 90 GB, such as 20 GB, could be allocated for data storage. The driver would then directly map logical addresses within 0-10 GB to the equivalent physical addresses in the boot volume, and indirectly map other logical addresses, via a logical-to-physical indirection layer, to provisioned physical addresses in the data volume.

### System Description

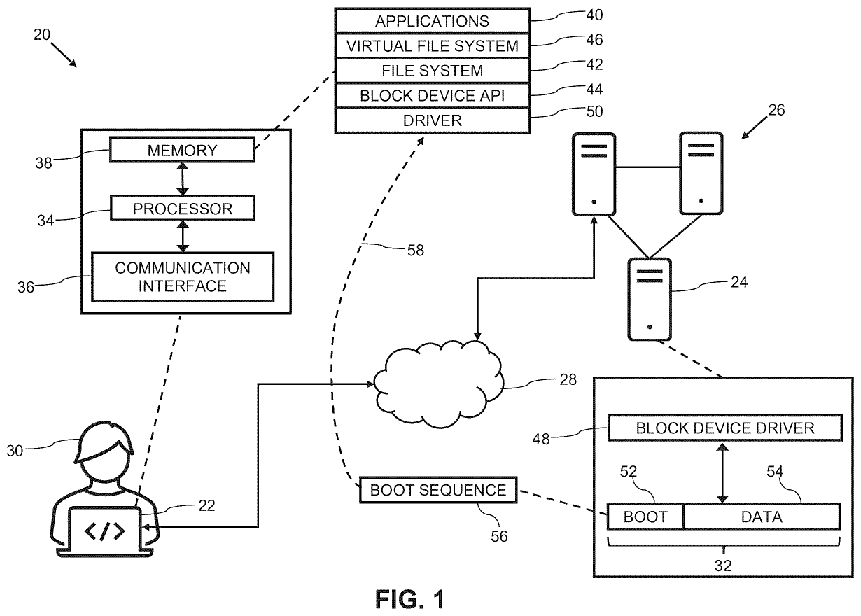

Reference is now made to FIG. 1, which is a schematic illustration of a system 20 for efficient remote block storage, in accordance with some embodiments of the present invention.

System 20 comprises a local device 22 and at least one remote device 24, such as at least one server belonging to a cloud-computing platform 26. Remote device 24 is networked with local device 22 over a network 28, such as the Internet. As described below, a user 30 uses local device 22 to allocate a block storage volume 32 on remote device 24. Block storage volume 32 includes a boot volume 52, which is not thin-provisioned, and a thin-provisioned block storage volume 54, which is used by local device 22 for remote storage of data.

Local device 22 comprises a processor 34, a communication interface 36, and a memory 38, such as a random access memory. Processor 34 is configured to exchange communication with remote device 24 via communication interface 36. Processor 34 is further configured to execute program instructions loaded into memory 38, including instructions for the execution of applications 40. For any application 40 that reads from or writes to block storage volume 32, a file system 42 (e.g., of type XFS™ or Ext4™) which is run by processor 34 on local device 22, interfaces between the application and the block device application programming interface (API) 44. Typically, a virtual file system 46 provides a layer of abstraction between applications 40 and file system 42.

In conventional remote block storage, block device application programming interface 44 interfaces directly with the block device driver 48 on remote device 24, which performs the low-level read and write operations on block storage volume 32. In some embodiments of the present invention, on the other hand, a driver 50 interposes between block device application programming interface 44 and block device driver 48. Alternatively, instead of file system 42 interfacing directly with block device application programming interface 44 (as is conventional), driver 50 interposes between file system 42 and block device application programming interface 44. By executing driver 50 or any other suitable program instructions in memory 38, processor 34 allocates block storage volume 54 for the storage of data, and logically concatenates block storage volume 54 with boot volume 52, as further described below with reference to the subsequent figures. Advantageously, the processor performs all this functionality without modifying the bootloader of remote device 24.

Typically, a boot sequence 56, which is defined in boot volume 52, includes a command to load driver 50, as indicated in FIG. 1 by an arrow 58. Any files required by boot sequence 56 prior to loading driver 50 are stored in boot volume 52. Subsequently to loading the driver, the driver allows the boot sequence to access, if necessary, other files stored in block storage volume 54.

In general, processor 34 may be embodied as a single processor, or as a cooperatively networked or clustered set of processors. The functionality of processor 34 described herein is typically implemented in software. For example, processor 34 may be embodied as a programmed processor comprising, for example, a central processing unit (CPU) and/or a Graphics Processing Unit (GPU). Program instructions, including software program instructions, and/or data may be loaded for execution and processing by the CPU and/or GPU. The program instructions and/or data may be downloaded to the processor in electronic form, over a network, for example. Alternatively or additionally, the program instructions and/or data may be provided and/or stored on non-transitory tangible media, such as magnetic, optical, or electronic memory. Such program instructions and/or data, when provided to the processor, produce a machine or special-purpose computer, configured to perform the tasks described herein.

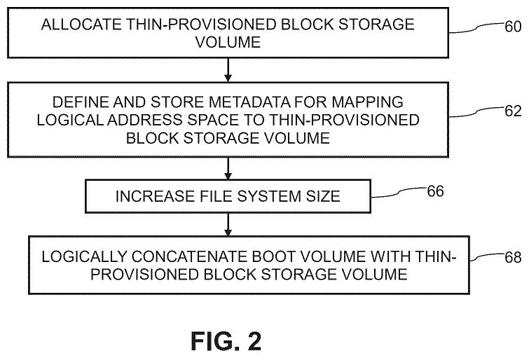

For further details regarding the functionality of driver 50, reference is now additionally made to FIG. 2, which is a flow diagram for operations performed by processor 34 in the execution of driver 50, in accordance with some embodiments of the present invention.

At an allocating step 60, the processor allocates thin-provisioned block storage volume 54. In some embodiments, in allocating step 60, the processor sets the physical size Z of volume 54 based on a configuration input from user 30 of local device 22 indicating the desired logical size Y of the thin-provisioned block storage volume, Y typically being specified in units of GB. For example, in some embodiments, the processor sets Z equal to Y/k, k being a predefined divisor greater than one. Alternatively, provided local device 22 initially uses, for data storage, another block storage volume that is not thin-provisioned (and is thus larger than necessary), the processor computes the size S of the data stored in the block storage volume, e.g., by running the command “df-h” in a Linux™ operating system. Subsequently, in allocating step 60, the processor sets Z based on S, e.g., by setting Z equal to S+c or S*(1+d) for a suitable constant c or d.

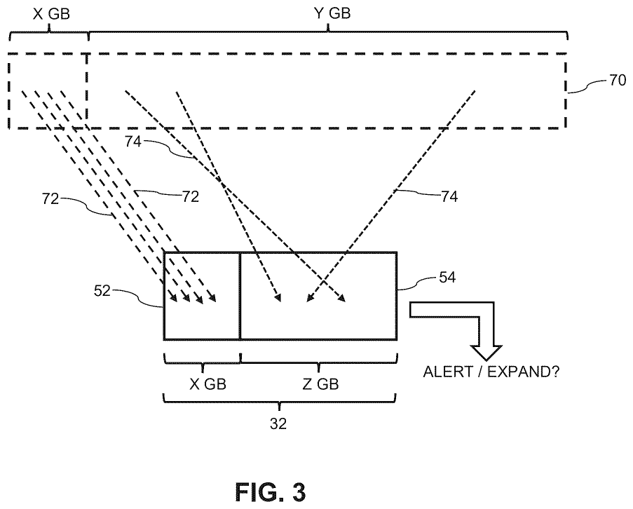

Next, at a defining-and-storing step 62, the processor defines and stores metadata for mapping the logical address space of file system 42 to the thin-provisioned block storage volume, this mapping being further described below with reference to FIG. 3. (The metadata can be stored on local device 22 or on remote device 24, e.g., at the head of the thin-provisioned block storage volume.) Subsequently, at a size-increasing step 66, the processor increases the size of file system 42 from the size of the boot volume to the total logical size of the boot volume and the thin-provisioned block storage volume.

Allocating step 60, defining-and-storing step 62, and size-increasing step 66 are performed immediately following the loading of the driver. Subsequently, at a concatenating step 68, the processor logically concatenates the thin-provisioned block storage volume with the boot volume with respect to read and write operations by file system 42, such that, from the perspective of the file system, these operations are performed on a single, unified block storage volume 32. (In the context of this concatenation, the adjective “logical” is applied to indicate that there is not necessarily any physical proximity between the boot volume and the thin-provisioned block storage volume; for example, these volumes may reside on different respective remote devices 24.)

It is noted that concatenating step 68 is performed on an ongoing basis as applications 40 read from and write to the block storage volume via file system 42. Similarly, the metadata for mapping the logical address space of file system 42 to the thin-provisioned block storage volume may be continually updated as data is written to and erased from the thin-provisioned block storage volume.

For further details regarding concatenating step 68, reference is now made to FIG. 3, which is a schematic illustration of a mapping between a logical address space 70, which is used by file system 42 (FIG. 1), and the unified storage volume 32 seen by the file system, in accordance with some embodiments of the present invention.

The processor logically concatenates thin-provisioned block storage volume 54 with boot volume 52 by mapping any logical address provided by the file system to the appropriate physical address in one of the two volumes. In particular, the processor maps any logical address less than the size X of the boot volume to the equivalent physical address in the boot volume, as indicated by mapping indicators 72. For example, for X=10 GB, logical addresses having values of 1, 5, and 9 GB are mapped to physical addresses having values of 1, 5, and 9 GB, respectively. On the other hand, the processor maps other logical addresses (i.e., any address greater than or equal to X) to provisioned physical addresses in the thin-provisioned block storage volume, as indicated by mapping indicators 74, based on the metadata defined and stored at defining-and-storing step 62 (FIG. 2). Thus, the user obtains Y GB of logical space for data storage with only Z<Y GB of physical space.

Typically, the processor continually checks the size of the data stored in the thin-provisioned block storage volume. In response to the thin-provisioned block storage volume being almost full (i.e., in response to the size of the stored data exceeding a predefined threshold), the processor outputs an alert, in response to which user 30 (FIG. 1) may expand (i.e., allocate additional storage for) the thin-provisioned block storage volume. Alternatively, in response to the thin-provisioned block storage volume being almost full, the processor automatically expands the thin-provisioned block storage volume.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A system for use with a boot volume, which is not thin-provisioned, on at least one remote device, the system comprising:
a memory, configured to load program instructions; and
a processor, configured to:
run a file system, and
by executing the program instructions:
allocate, for storage of data, a thin-provisioned block storage volume on the at least one remote device, and
logically concatenate the thin-provisioned block storage volume with the boot volume with respect to read and write operations by the file system, by:
mapping any logical address provided by the file system and less than a size of the boot volume to an equivalent physical address in the boot volume, and
mapping other logical addresses provided by the file system to provisioned physical addresses in the thin-provisioned block storage volume.

2. The system according to claim 1, wherein the processor is configured to allocate the thin-provisioned block storage volume, and to logically concatenate the thin-provisioned block storage volume with the boot volume, without modifying a bootloader of the remote device.

3. A method for use with a boot volume, which is not thin-provisioned, on at least one remote device, the method comprising:
using a processor of a local device, allocating, for storage of data, a thin-provisioned block storage volume on the at least one remote device, and
using the processor, logically concatenating the thin-provisioned block storage volume with the boot volume with respect to read and write operations by a file system running on the local device, by:
mapping any logical address provided by the file system and less than a size of the boot volume to an equivalent physical address in the boot volume, and
mapping other logical addresses provided by the file system to provisioned physical addresses in the thin-provisioned block storage volume.

4. The method according to claim 3, wherein the remote device belongs to a cloud-computing platform.

5. The method according to claim 3, wherein allocating the thin-provisioned block storage volume and logically concatenating the thin-provisioned block storage volume with the boot volume comprises allocating the thin-provisioned block storage volume and logically concatenating the thin-provisioned block storage volume with the boot volume without modifying a bootloader of the remote device.

6. The method according to claim 3, wherein logically concatenating the thin-provisioned block storage volume with the boot volume comprises logically concatenating the thin-provisioned block storage volume with the boot volume while interposing between a block device application program interface of the local device and a block device driver of the remote device.

7. The method according to claim 3, wherein allocating the thin-provisioned block storage volume comprises setting a physical size of the thin-provisioned block storage volume based on a configuration input from a user of the local device indicating a desired logical size of the thin-provisioned block storage volume.

8. The method according to claim 3,
wherein the local device initially uses, for the storage of the data, another block storage volume that is not thin-provisioned,
wherein the method further comprises computing a size of the data stored in the block storage volume, and
wherein allocating the thin-provisioned block storage volume comprises setting a physical size of the thin-provisioned block storage volume based on the size of the data.

9. The method according to claim 3, further comprising outputting an alert in response to the thin-provisioned block storage volume being almost full.

10. The method according to claim 3 further comprising expanding the thin-provisioned block storage volume in response to the thin-provisioned block storage volume being almost full.

11. A computer software product for use with a boot volume, which is not thin-provisioned, on at least one remote device, the computer software product comprising a tangible non-transitory computer-readable medium in which program instructions are stored, which instructions, when read by a processor of a local device on which a file system runs, cause the processor to:
allocate, for storage of data, a thin-provisioned block storage volume on the at least one remote device, and
logically concatenate the thin-provisioned block storage volume with the boot volume with respect to read and write operations by the file system, by:
mapping any logical address provided by the file system and less than a size of the boot volume to an equivalent physical address in the boot volume, and
mapping other logical addresses provided by the file system to provisioned physical addresses in the thin-provisioned block storage volume.

12. The computer software product according to claim 11, wherein the remote device belongs to a cloud-computing platform.

13. The computer software product according to claim 11, wherein the instructions cause the processor to allocate the thin-provisioned block storage volume, and to logically concatenate the thin-provisioned block storage volume with the boot volume, without modifying a bootloader of the remote device.

14. The computer software product according to claim 11, wherein the program instructions include a driver.

15. The computer software product according to claim 11, wherein a boot sequence defined in the boot volume includes a command to load the program instructions.

16. The computer software product according to claim 11, wherein the instructions cause the processor to logically concatenate the thin-provisioned block storage volume with the boot volume while interposing between a block device application program interface of the local device and a block device driver of the remote device.

17. The computer software product according to claim 11, wherein the instructions cause the processor, in allocating the thin-provisioned block storage volume, to set a physical size of the thin-provisioned block storage volume based on a configuration input from a user of the local device indicating a desired logical size of the thin-provisioned block storage volume.

18. The computer software product according to claim 11,
wherein the local device initially uses, for the storage of the data, another block storage volume that is not thin-provisioned,
wherein the instructions further cause the processor to compute a size of the data stored in the block storage volume, and
wherein the instructions cause the processor, in allocating the thin-provisioned block storage volume, to set a physical size of the thin-provisioned block storage volume based on the size of the data.

19. The computer software product according to claim 11, wherein the instructions further cause the processor to output an alert in response to the thin-provisioned block storage volume being almost full.

20. The computer software product according to claim 11, wherein the instructions further cause the processor to expand the thin-provisioned block storage volume in response to the thin-provisioned block storage volume being almost full.
